(19) United States
(12) Patent Application Publication
(10) Pub. No.: US 2023/0260110 A1
(43) Pub. Date: Aug. 17, 2023

(54) METHOD AND APPARATUS FOR PROCESSING ABNORMAL REGION IN IMAGE, AND IMAGE SEGMENTATION METHOD AND APPARATUS

(71) Applicant: BEIJING ESCOPE TECH CO., LTD., Beijing (CN)

(72) Inventor: Chunliang WANG, Tianjin (CN)

(21) Appl. No.: 18/006,955

(22) PCT Filed: Mar. 3, 2021
(86) PCT No.: PCT/CN2021/078882

§ 371 Date: Jan. 26, 2023

(30) Foreign Application Priority Data
Aug. 11, 2020 (CN) 202010803078.2

(51) Int. Cl. G06T 7/00; G06T 7/11; G06T 5/00

(52) U.S. Cl. CPC G06T 7/0012; G06T 7/11; G06T 7/0004; G06T 5/005; G06T 2207/20081; G06T 2207/20076; G06T 2207/20084

(57) ABSTRACT

The present disclosure relates to a processing method of an abnormal region in an image and an apparatus, and relates to the technical field of image processing. The method includes: generating, for a region to be examined consisting of any one or more pixels in an image to be processed, a plurality of regions to be processed including the region to be examined; respectively calculating respective predicted pixel values of the region to be examined, by using a first machine learning model, according to pixel values in a preset range outside respective regions to be processed; calculating prediction error distributions corresponding to the respective predicted pixel values as a first error distribution, according to original pixel values of the region to be examined; and determining whether the region to be examined belongs to the abnormal region in the image to be processed, according to the first error distribution.

### CROSS-REFERENCE TO RELATED APPLICATIONS

The present application claims the priority of Chinese patent application No. 202010803078.2, filed on Aug. 11, 2020, the entire disclosure of which is incorporated herein by reference as part of the disclosure of this application.

### TECHNICAL FIELD

The present disclosure relates to a field of image processing technologies, and more particularly, to a processing method of an abnormal region in an image, a processing apparatus of an abnormal region in an image, an image segmentation method, an image segmentation apparatus, an electronic device, and a non-volatile computer readable storage medium.

### BACKGROUND

At present, image recognizing and segmentation technologies have been widely applied to fields such as computer vision, medical image analysis, etc. For example, machine learning based on supervised training may be used to implement functions such as face recognition, automatic driving, tumor examination, etc.

However, due to limitations of training data sampling, it is impossible to include all situations that may occur in practical applications. For example, in practical application, a trained machine learning model usually encounters abnormal regions included in images. These abnormal regions include objects or image representations that never appear in the training, thereby causing the machine learning model to make wrong judgments or predictions.

In the related technology, in the case of disturbance by abnormal regions, deep generation networks such as an automatic encoder and a generative adversarial network may be used to generate undisturbed clean image characteristics. An automatic encoder or a generative adversarial network trained with clean images is used to reconstruct images.

### SUMMARY

According to some embodiments of the present disclosure, a processing method of an abnormal region in an image is provided. The processing method comprises: generating, for a region to be examined consisting of any one or more pixels in an image to be processed, a plurality of regions to be processed comprising the region to be examined; respectively calculating respective predicted pixel values of the region to be examined, by using a first machine learning model, according to pixel values in a preset range outside respective regions to be processed; calculating prediction error distributions corresponding to the respective predicted pixel values as a first error distribution, according to original pixel values of the region to be examined; and determining whether the region to be examined belongs to the abnormal region in the image to be processed, according to the first error distribution.

In some embodiments, determining whether the region to be examined belongs to the abnormal region in the image to be processed, according to the first error distribution, comprises: determining whether the region to be examined belongs to the abnormal region in the image to be processed, according to whether a difference between the first error distribution and a second error distribution is greater than a first threshold, where the second error distribution is capable of characterizing a prediction error distribution of an image not comprising the abnormal region.

In some embodiments, the second error distribution is determined in one of modes below:

determining the second error distribution according to the first machine learning model processing prediction error distributions of other images not comprising the abnormal region; determining the second error distribution according to a standard deviation of first error distributions of all pixels in the image to be processed; or, determining the second error distribution by using a second machine learning model, according to the image to be processed.

In some embodiments, determining whether the region to be examined belongs to the abnormal region in the image to be processed, according to whether the difference between the first error distribution and the second error distribution is greater than the first threshold, comprises: a generation step: replacing all pixels belonging to the abnormal region with corresponding predicted pixel values to generate a candidate image; an update step: updating the second error distribution according to the candidate image, by using the plurality of regions to be processed and the first machine learning model, or updating the second error distribution according to the candidate image, by using a second machine learning model; and a determining step: re-determining whether the region to be examined belongs to the abnormal region, according to whether the difference between the first error distribution and the second error distribution that is updated is greater than the first threshold.

In some embodiments, determining whether the region to be examined belongs to the abnormal region in the image to be processed, according to whether the difference between the first error distribution and the second error distribution is greater than the first threshold, comprises: repeating the generation step, the update step, and the determining step, until an iteration condition is met, so as to determine whether respective regions to be examined in the image to be processed belong to the abnormal region.

In some embodiments, updating the second error distribution according to the candidate image, by using the plurality of regions to be processed and the first machine learning model, comprises: calculating respective predicted pixel values of the region to be examined in the candidate image, by using the first machine learning model, according to the plurality of regions to be processed; determining a prediction error distribution of the region to be examined in the candidate image, according to the respective predicted pixel values of the candidate image; and updating the second error distribution, by using the prediction error distribution of the region to be examined in the candidate image.

In some embodiments, re-determining whether the region to be examined belongs to the abnormal region, according to whether the difference between the first error distribution and the second error distribution that is updated is greater than the first threshold, comprises: determining whether respective regions to be examined in the image to be processed belong to the abnormal region, according to whether a difference between second error distributions of candidate images in two adjacent iterations is greater than a second threshold.

In some embodiments, re-determining whether the region to be examined belongs to the abnormal region, according to whether the difference between the first error distribution and the second error distribution that is updated is greater than the first threshold, comprises: generating a candidate pixel set, according to the pixels determined to belong to the abnormal region; calculating a first probability that respective pixels do not belong to the abnormal region, according to the second error distribution of the respective pixels in the candidate image, and calculating a second probability of the respective pixels, according to the difference between the first error distribution and the second error distribution of the respective pixels in the candidate image; generating an objective function, according to a posteriori probability of the pixel set determined based on the first probability and the second probability; and solving the objective function by taking the pixels in the candidate pixel set as variables and taking maximization of the posterior probability as a condition, so as to determine which pixels in the candidate image belong to the abnormal region.

In some embodiments, the processing method further comprises: determining a clean image not comprising the abnormal region, according to the candidate image generated when an iteration condition is met.

In some embodiments, determining whether the region to be examined belongs to the abnormal region in the image to be processed, according to whether the difference between the first error distribution and the second error distribution is greater than the first threshold, comprises: determining the difference according to cross entropy of the first error distribution and the second error distribution.

In some embodiments, the first threshold is determined according to a standard deviation of the difference.

In some embodiments, generating, for the region to be examined consisting of any one or more pixels in the image to be processed, the plurality of regions to be processed comprising the region to be examined, comprises: by superimposing a plurality of masks on the image to be processed, forming a plurality of first blank regions which are respectively taken as one region to be processed of the respective first blank regions that comprises a region to be examined; moving the plurality of masks to form a plurality of second blank regions, which are respectively taken as another region to be processed of the respective second blank regions that comprises a region to be examined; and constantly moving the plurality of masks, until all regions to be examined in the image to be processed have a plurality of regions to be processed.

In some embodiments, the image to be processed is a biological medical image, and the abnormal region is a non-biological region or an abnormal biological region; or, the image to be processed is an industrial product image, and the abnormal region is a damaged region or a scratched region.

According to some other embodiments of the present disclosure, an image segmentation method is provided. The image segmentation method comprises: examining an abnormal region in an image to be processed, according to the processing method of the abnormal region in the image according to any embodiments described above; and performing image segmentation on a generated clean image not comprising the abnormal region, so as to determine an image segmentation result of the image to be processed.

According to some other embodiments of the present disclosure, a processing apparatus of an abnormal region in an image is provided. The processing apparatus comprises: a generating circuit, configured to generate, for a region to be examined consisting of any one or more pixels in an image to be processed, a plurality of regions to be processed comprising the region to be examined; a predicted value calculating circuit, configured to respectively calculate respective predicted pixel values of the region to be examined, by using a first machine learning model, according to pixel values in a preset range outside respective regions to be processed; a distribution calculating circuit, configured to calculate prediction error distributions corresponding to the respective predicted pixel values as a first error distribution, according to original pixel values of the region to be examined; and a determining circuit, configured to determine whether the region to be examined belongs to the abnormal region in the image to be processed, according to the first error distribution.

In some embodiments, the determining circuit determines whether the region to be examined belongs to the abnormal region in the image to be processed, according to whether a difference between the first error distribution and a second error distribution is greater than a first threshold, where the second error distribution is capable of characterizing a prediction error distribution of an image not comprising the abnormal region.

In some embodiments, the distribution calculating circuit determines the second error distribution in one of modes below: determining the second error distribution according to the first machine learning model processing prediction error distributions of other images not comprising the abnormal region; determining the second error distribution according to a standard deviation of first error distributions of all pixels in the image to be processed; or, determining the second error distribution by using a second machine learning model, according to the image to be processed.

In some embodiments, the processing apparatus further comprises a producing circuit, configured to execute a generation step, and replace all pixels belonging to the abnormal region with corresponding predicted pixel values to generate a candidate image; the distribution calculating circuit executes an update step, updates the second error distribution according to the candidate image, by using the plurality of regions to be processed and the first machine learning model, or updates the second error distribution according to the candidate image, by using a second machine learning model; and the determining circuit executes a determining step, re-determines whether the region to be examined belongs to the abnormal region, according to whether the difference between the first error distribution and the second error distribution that is updated is greater than the first threshold.

In some embodiments, the producing circuit, the distribution calculating circuit, and the determining circuit repeat the generation step, the update step, and the determining step, until an iteration condition is met, so as to determine whether respective regions to be examined in the image to be processed belong to the abnormal region.

In some embodiments, the predicted value calculating circuit calculates respective predicted pixel values of the region to be examined in the candidate image, by using the first machine learning model, according to the plurality of regions to be processed; the distribution calculating circuit determines a prediction error distribution of the region to be examined in the candidate image, according to the respective predicted pixel values of the candidate image; and the distribution calculating circuit updates the second error distribution, by using the prediction error distribution of the region to be examined in the candidate image.

In some embodiments, the determining circuit determines whether respective regions to be examined in the image to be processed belong to the abnormal region, according to whether a difference between second error distributions of candidate images in two adjacent iterations is greater than a second threshold.

In some embodiments, the determining circuit generates a candidate pixel set, according to the pixels determined to belong to the abnormal region, calculates a first probability that respective pixels do not belong to the abnormal region, according to the second error distribution of the respective pixels in the candidate image, and calculates a second probability of the respective pixels, according to the difference between the first error distribution and the second error distribution of the respective pixels in the candidate image, generates an objective function, according to a posteriori probability of the pixel set determined based on the first probability and the second probability, and solves the objective function by taking the pixels in the candidate pixel set as variables and taking maximization of the posterior probability as a condition, so as to determine which pixels in the candidate image belong to the abnormal region.

In some embodiments, the producing circuit is configured to determine a clean image not comprising the abnormal region, according to the candidate image generated when an iteration condition is met.

In some embodiments, the determining circuit determines the difference according to cross entropy of the first error distribution and the second error distribution.

In some embodiments, the first threshold is determined according to a standard deviation of the difference.

In some embodiments, the generating circuit, by superimposing a plurality of masks on the image to be processed, forms a plurality of first blank regions which are respectively taken as one region to be processed of the respective first blank regions that comprises a region to be examined, moves the plurality of masks to form a plurality of second blank regions, which are respectively taken as another region to be processed of the respective second blank regions that comprises a region to be examined; and constantly moves the plurality of masks, until all regions to be examined in the image to be processed have a plurality of regions to be processed.

In some embodiments, the image to be processed is a biological medical image, and the abnormal region is a non-biological region or an abnormal biological region; or, the image to be processed is an industrial product image, and the abnormal region is a damaged region or a scratched region.

According to some other embodiments of the present disclosure, an image segmentation apparatus is provided. The image segmentation apparatus comprises: an examining circuit, configured to examine an abnormal region in an image to be processed, according to the processing method of the abnormal region in the image according to any embodiment described above; and a segmentation circuit, configured to perform image segmentation on a generated clean image not comprising the abnormal region, so as to determine an image segmentation result of the image to be processed.

According to some other embodiments of the present disclosure, an electronic device is provided. The electronic device comprises: a memory; and a processor coupled to the memory. The processor is configured to execute the processing method of the abnormal region in the image according to any embodiment described above, or the image segmentation method according to any embodiment described above, based on instructions stored in the memory.

According to some other embodiments of the present disclosure, a non-volatile computer readable storage medium is provided. The non-volatile computer readable storage medium has a computer program stored thereon. The program, when executed by a processor, implements the processing method of the abnormal region in the image according to any embodiment described above, or the image segmentation method according to any embodiment described above.

### BRIEF DESCRIPTION OF THE DRAWINGS

The accompanying drawings described herein are used to provide a further understanding of the present disclosure and form a part of the present disclosure. The schematic embodiments and descriptions of the present disclosure are used to explain the present disclosure and do not constitute an improper limitation of the present disclosure. In the drawings:

FIG. 1 shows a flow chart of some embodiments of a processing method of an abnormal region in an image according to the present disclosure;

FIG. 2a shows a schematic diagram of some embodiments of a processing method of an abnormal region in an image according to the present disclosure;

FIG. 2b shows a schematic diagram of some embodiments of a processing method of an abnormal region in an image according to the present disclosure;

FIG. 2c shows a schematic diagram of some embodiments of a processing method of an abnormal region in an image according to the present disclosure;

FIG. 3 shows a flow chart of some embodiments of step 140 of FIG. 1;

FIG. 4 shows a block diagram of some embodiments of a processing apparatus of an abnormal region in an image according to the present disclosure;

FIG. 5 shows a block diagram of some embodiments of an electronic device according to the present disclosure; and

FIG. 6 shows a block diagram of some other embodiments of an electronic device according to the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. The following description of at least one exemplary embodiment is in fact only illustrative and in no way serves as any restriction on the present disclosure and its application or use. Based on the described embodiments herein, those skilled in the art can obtain other embodiment(s), without any inventive work, which should be within the scope of the disclosure.

Unless otherwise specified, relative arrangement, numerical expressions, and numerical values of components and steps as described in these embodiments do not limit the scope of the present disclosure. Meanwhile, it should be understood that, for convenience of description, sizes of respective parts shown in the drawings are not drawn according to an actual scale relationship. The technologies, methods and devices known to those ordinarily skilled in the art may not be discussed in detail, but in appropriate cases, the technologies, methods and devices shall be considered as part of the authorized specification. In all the examples shown and discussed herein, any specific value should be interpreted as merely illustrative and not as a limitation. Therefore, other examples of the exemplary embodiments may have different values. It should be noted that: similar reference signs and letters indicate similar items in the drawings below; and therefore, once a certain item is defined in one drawing, it does not need to be further discussed in subsequent drawings.

The inventor of the present disclosure finds that there are following problems in the above-described related technologies: a certain amount of image samples including abnormal regions are required to train a deep neural network, which makes examination of abnormal regions difficult to adapt to various actual situations, thereby leading to degradation of examination performance of abnormal regions.

In view of this, the present disclosure proposes a processing technical solution of an abnormal region in an image, which can improve examination performance of abnormal regions.

As described above, due to limitations of training data sampling, it is impossible to include all possible situations in actual situations. Therefore, in practice, the trained machine learning model may encounter the case where the image to be processed includes an object or image representation that does not appear in the training, thereby causing the model to make wrong judgments or predictions.

For example, in the field of medical imaging, patients may have implanted some medical devices (e.g., pacemakers, etc.) in their bodies before image acquisition, or may wear some additional objects (e.g., buttons, necklaces, etc.) during image acquisition. These abnormal regions are usually referred to as foreign bodies in medical images, which are very easy to cause failure of network segmentation or network classification.

Therefore, it is difficult to effectively examine these abnormal regions in the image to be processed through supervised learning.

Based on the above-described technical problems, the present disclosure proposes an examination technical solution of an unsupervised pixel-level image abnormal region (the region where the abnormal region is located). The technical solution is based on an image inpainting technology to establish prediction models of respective regions in the image, and implement unsupervised learning without training data including abnormal region labels.

In this way, the technical solution may automatically examine the region where the abnormal region exists on the image, and has a fairly high accuracy. Moreover, the technical solution can also remove the examined abnormal region from the image to be processed, so as to obtain a clean image for further image processing (e.g., segmentation, classification, etc.).

For example, the above-described technical solution can be implemented through embodiments below.

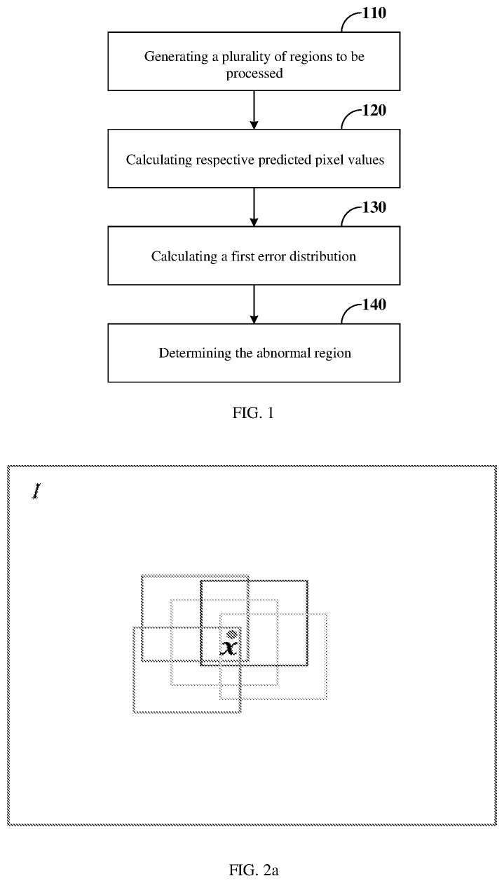

FIG. 1 shows a flow chart of some embodiments of a processing method of an abnormal region in an image according to the present disclosure.

As shown in FIG. 1, the method includes: step 110, generating a plurality of regions to be processed; step 120, calculating respective predicted pixel values; step 130, calculating a first error distribution; and step 140, determining the abnormal region.

In step 110, for a region to be examined consisting of any one or more pixels in the image to be processed, a plurality of regions to be processed including the region to be examined is generated. For example, the region to be examined may be any one pixel in the image to be processed, and the region to be examined is a region where a certain disturbing object is located.

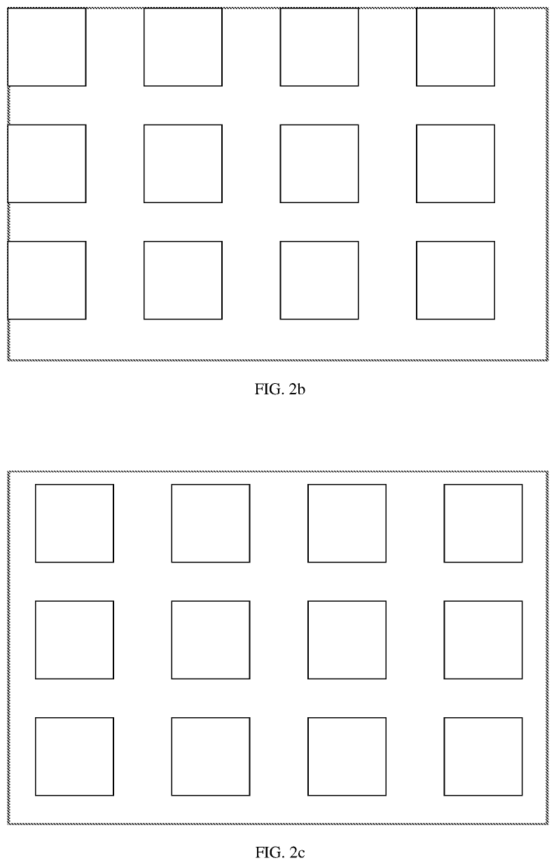

In some embodiments, for example, step 110 may be implemented through the embodiment in FIG. 2a.

FIG. 2a shows a schematic diagram of some embodiments of the processing method of the abnormal region in the image according to the present disclosure.

As shown in FIG. 2a, with respect to any one pixel x in an image to be processed I, a plurality of regions to be processed including the pixel are formed for each pixel x in the image to be processed. These regions to be processed may be “holes” with different sizes, positions, and shapes. For example, a shape of a “hole” may be rectangular, or may also be any shape, or even irregular.

In some embodiments, according to the prior knowledge, the size of the “hole” may be set according to a size of a largest abnormal region.

These “holes” are used as masks to superimpose on a region where a certain pixel to be processed is located. All original pixel values in the “holes” may be set to 0 to form a masked region, so that a pixel value of the pixel to be processed may be taken as a prediction object.

In some embodiments, each pixel in the image to be processed needs to be processed as above, that is, each pixel in the image to be processed needs to be traversed. For example, a certain step length may be set according to elements such as size of the image to be processed, size of the abnormal region, examination requirements, etc.; and according to the step length, the respective “holes” are moved on the image to be processed, so as to implement mask processing for each pixel.

In some embodiments, in order to improve traversal efficiency, a “hole” group of a grid form may be used to implement parallel processing of a plurality of pixels. For example, parallel processing may be implemented through the embodiments of FIG. 2b and FIG. 2c.

FIG. 2b and FIG. 2c show schematic diagrams of some embodiments of the processing method of the abnormal region in the image according to the present disclosure.

As shown in FIG. 2b, a plurality of masks (small rectangular boxes in the figure) may be used to superimpose on the image to be processed, so as to form a plurality of first blank regions, which are respectively taken as one region to be processed of the respective first blank regions that includes pixels.

As shown in FIG. 2c, these masks are moved to form a plurality of second blank regions, which are respectively taken as another region to be processed of the respective second blank region that includes pixels; the plurality of masks are constantly moved until all pixels in the image to be processed have a plurality of regions to be processed.

After the blank regions including the respective pixels are formed on the image to be processed, pixel value prediction may be performed through other steps in FIG. 1.

In step 120, respective predicted pixel values of the region to be examined is respectively calculated, by using the first machine learning model, according to pixel values in a preset range outside the respective regions to be processed.

In some embodiments, with respect to the pixel x of the masked region in the image to be processed, a predicted value I′(x) of a gray value (pixel value) I(x) on an x point may be predicted through an inpainting function I′(x)=g(M, x), where, M is a region to be processed including x, namely, the “hole”. g(M, x) may be a machine learning model, for example, partial convolutional neural network (PCNN).

In some embodiments, because one pixel x has a plurality of regions to be processed, a plurality of I′(x) may be obtained. In this way, a plurality of prediction errors εₓ=I(x)−I′(x) may be calculated according to I(x) and the plurality of I′(x) corresponding thereto.

Because the abnormal region where the abnormal region is located and the normal region in the image to be processed have different prediction errors εₓ, whether the pixel belongs to the abnormal region may be determined according to a prediction error of each pixel.

However, the prediction error is related to many factors such as size and shape of the “hole”, and accuracy is low if the abnormal region is examined only depending on εₓ. Therefore, the present disclosure predicts one pixel by using a plurality of regions to be processed, so as to obtain an error distribution Pₐ(εₓ) of εₓ. The abnormal region can be examined more accurately through Pₐ(εₓ).

In step 130, according to original pixel values of the region to be examined, the prediction error distributions corresponding to the respective predicted pixel values are calculated as a first error distribution.

In some embodiments, because there are a plurality of regions to be processed set for each pixel according to the present disclosure, a plurality of prediction errors εₓ can be calculated for each pixel x. In this way, the prediction error distribution Pₐ(εₓ) of εₓ can be obtained. For example, Pₐ(εₓ) may be calculated through the probability density function (PDF) of εₓ.

In some embodiments, because the abnormal region where the abnormal region is located and the normal region in the image to be processed have different prediction error distributions Pₐ(εₓ), whether the pixel belongs to the abnormal region may be determined according to Pₐ(εₓ) of each pixel.

In step 140, whether the region to be examined belongs to the abnormal region in the image to be processed is determined according to the first error distribution. It may be optional to send a warning message about the abnormal region to a user. For example, the image to be processed is a biological medical image, and the abnormal region is a non-biological object; or the image to be processed is an industrial product image, and the abnormal region is a damaged region or a scratched region.

In some embodiments, whether the pixel belongs to the abnormal region in the image to be processed is judged, according to whether the difference between the first error distribution and the second error distribution is greater than the first threshold. The second error distribution is capable of characterizing a prediction error distribution of an image not including an abnormal region.

For example, according to the prior knowledge, it may be known that the prediction error distribution P_{b}(εₓ) in the normal region is the second error distribution, which usually presents a narrow width unimodal distribution characteristic. In the case where Pₐ(εₓ) does not meet the above-described distribution characteristic, it may be judged that pixel x belongs to the abnormal region.

In some embodiments, the difference is determined according to cross entropy of the first error distribution and the second error distribution. Cross entropy is a Kullback-Leibler (KL) divergence.

In some embodiments, the first threshold may be determined according to a standard deviation of the difference. For example, 3 times the standard deviation of the cross entropy may be taken as the first threshold.

In some embodiments, in the case where a clean image not including the abnormal region cannot be directly obtained, P_{b}(εₓ) cannot be directly obtained. In this case, an iteration method may be adopted to gradually improve judgment of the abnormal region and estimation of a prediction error of the clean image.

In the above-described embodiment, a plurality of predictions are performed for a pixel value of each pixel in the image to be processed, and the prediction error distribution is determined based on the plurality of predicted values, and is taken as a basis for examining the abnormal region. In this way, the difference between prediction error distributions of the normal region in the image to be processed and the abnormal region may be used to deeply mine features of the abnormal region without abnormal region training data, so as to improve examination performance of the abnormal region.

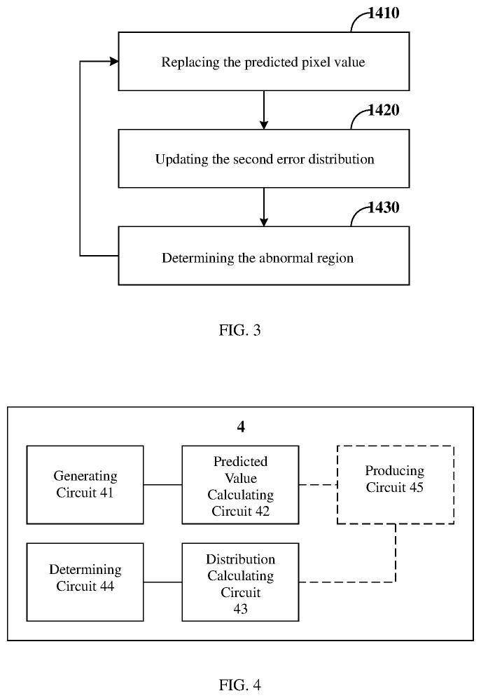

For example, step 140 may be implemented through the embodiment in FIG. 3.

FIG. 3 shows a flow chart of some embodiments of step 140 of FIG. 1.

As shown in FIG. 3, step 140 includes: step 1410, replacing the predicted pixel value; step 1420, updating the second error distribution; and step 1430: determining the abnormal region.

In step 1410, all pixel values belonging to the abnormal region are replaced with corresponding predicted pixel values, so as to generate a candidate image. For example, a clean image not including the abnormal region may be determined according to the candidate image generated when the iteration condition is met.

In some embodiments, the abnormal region in the image to be processed is examined, according to the processing method of the abnormal region in the image according to any one of the above-described embodiments; and the generated clean image not including the abnormal region is segmented, so as to determine an image segmentation result of the image to be processed. For example, the clean image not including the abnormal region output by the processing method according to any one of the above-described embodiments may be taken as an input of another image segmentation module.

In some embodiments, a new region to be processed may be created by using all pixel sets belonging to the abnormal region. The second machine learning model is used to predict pixel values in the new region to be processed. The predicted pixel values are used to replace the pixel values of corresponding regions in the image to be processed so as to generate a candidate image.

In some embodiments, with respect to the image to be processed I, Dₖₗⁱ is a difference value (e.g., the KL divergence) between the first error distribution and the second error distribution obtained by an ith iteration.

For example, Pₐ(εₓ) and P_{b}(εₓ) are all in normal distribution. In this way, it is needed to acquire averages and standard deviations of Pₐ(εₓ) and P_{b}(εₓ), so as to calculate KL divergences of the two; and histograms of Pₐ(εₓ) and P_{b}(εₓ) may also be generated, and then the KL divergences of the two histograms are calculated.

In some embodiments, a prediction error distribution of other image not including the abnormal region is processed according to the machine learning model, and the second error distribution is determined as an initial value of P_{b}(εₓ).

For example, a plurality of other images not including the abnormal region may be pre-generated as training data; and the prediction error distribution P_{b}(εₓ) may be calculated through the above-described “hole” and the inpainting function I′(x)=g(M, x) and may be taken as the second error distribution, so as to determine an initial iteration value Dₖₗ⁰.

In some embodiments, because an area of the abnormal region usually has a small proportion in the image to be processed, the second error distribution may be determined by using a statistical method and taken as an initial value of P_{b}(εₓ).

For example, the second error distribution may be determined according to a standard deviation of the first error distribution of all pixels in the image to be processed, so as to determine the initial iteration value Dₖₗ⁰.

In some embodiments, the prediction error distribution P_{b}(εₓ) of pixels in the clean image usually meets a normal distribution N(0, σ₀) with zero as an average and with σ₀ as a standard deviation. An initial value of σ₀ may be determined through the above-described embodiments. For example, σ₀ may be set as a median of the standard deviations of the prediction errors of all pixels in the image to be processed.

In some embodiments, after the KL divergence initial value Dₖₗ⁰ is determined, the respective initial values M⁰ of the “holes” masking the abnormal region may be determined according to the first threshold.

For example, the first threshold may be determined by analyzing a range of Dₖₗ⁰ of the clean images in the training set. For example, the first threshold may be 3 times the standard deviation of Dₖₗ⁰.

After M⁰ is determined, the trained inpainting neural network may be used to determine pixel values of the Mₐ⁰ masked region, so as to fill these M⁰ with the “normal” pixel values, to generate the candidate image I_{b}^{o}, of this iteration.

In step 1420, according to the candidate image, the second error distribution is updated by using a plurality of regions to be processed and the first machine learning model. For example, image inpainting may be performed on the candidate image I_{b}^{o}, so as to determine the prediction error distribution P_{b}¹(εₓ) of this iteration. Optionally, P_{b}¹(εₓ) is directly speculated by training the second machine learning model.

In some embodiments, the respective predicted pixel values of the pixel in the candidate image are calculated, by using the first machine learning model, according to the plurality of regions to be processed; the prediction error distribution of the pixel in the candidate image is determined according to the respective predicted pixel values of the candidate image; the second error distribution is updated, by using the prediction error distribution of the pixel in the candidate image.

In some embodiments, the prediction error distribution is directly estimated by using a new machine learning model (the second machine learning model), with the candidate image as the input, and with an average and a standard deviation of each pixel as the output, so as to update the second error distribution. The new machine learning model may be trained by using the prediction error distribution generated by using the inpainted first machine learning model above. In step 1430, whether the pixel belongs to the abnormal region is re-determined, according to whether the difference between the first error distribution and the updated second error distribution is greater than the first threshold.

In some embodiments, a new first threshold may be determined, according to Dₖₗ¹ of Pₐ(εₓ) and P_{b}¹(εₓ); the “hole” M¹ masking the abnormal region in this iteration may be determined according to the new first threshold. By performing image inpainting on the Mₐ⁰ masked region, the iterative image I_{b}¹ may be updated.

In some embodiments, the above-described steps may be repeated, until the iteration condition is met, so as to determine whether the respective pixels in the image to be processed belong to the abnormal region. For example, the iteration condition may be set according to the amount of iterations, or may be set according to whether the “hole” masking the abnormal region tends to be stable.

In this way, Dₖₗⁱ, P_{b}ⁱ(εₓ) and Mⁱ are constantly updated through iteration, so that the abnormal region and the clean image which are more and more accurate may be obtained.

In some embodiments, in order to avoid P_{b}ⁱ(εₓ) from drifting toward Pₐ(εₓ) during iteration, that is, the predicted clean image (candidate image) is getting closer and closer to the input polluted image (image to be processed), error correction check processing may be added when updating Mⁱ. For example, error correction check processing may be implemented by using the method according to any one of embodiments below.

In some embodiments, whether the respective pixels in the image to be processed belong to the abnormal region is determined, according to whether a difference between the second error distributions of the candidate image in two adjacent iterations is greater than the second threshold.

For example, image inpainting processing is performed according to Mᵢ of this iteration, so as to obtain a candidate image I_{b}ⁱ of this iteration; a KL divergence ΔDₖₗⁱ between I_{b}ⁱ and I_{b}ⁱ⁻¹ of a previous iteration is calculated. If ΔDₖₗⁱ exceeds the second threshold, it is considered that the Mⁱ masked region is the abnormal region; a union of abnormal regions determined according to the two KL divergences Dₖₗⁱ and ΔDₖₗⁱ may be determined as the abnormal region including the abnormal region in this iteration.

For example, in order to ensure that the “hole” may mask the pixels of all the abnormal regions in the image inpainting process, the “hole” is expanded by several pixels (e.g., 3 pixels) as a new “hole” in each threshold update operation.

In some embodiments, a candidate pixel set is generated, according to the pixels determined to belong to the abnormal region; the first probability that the respective pixels do not belong to the abnormal region is calculated, according to the second error distribution of the respective pixels in the candidate image; the second probability of the respective pixels is calculated, according to the difference between the first error distribution and the second error distribution of the respective pixels in the candidate image; an objective function is generated, according to the posteriori probability of the pixel set determined based on the first probability and the second probability; the objective function is solved, by taking the pixels in the candidate pixel set as variables, and taking maximization of the posterior probability as a condition, so as to determine which pixels in the candidate image belong to the abnormal region.

For example, estimation of Mⁱ masking the abnormal region of this iteration may be taken as an optimization problem with respect to the posterior probability P(Mⁱ|Pₐ(εₓ), P_{b}ⁱ(εₓ))∝P(Pₐ(εₓ)|Mⁱ=1)·P(P_{b}ⁱ(εₓ)|Mⁱ=0). That is, an Mⁱ is looked for, rendering a maximal probability that the Mⁱ masked region is the abnormal region, and a maximal probability that the region not masked by Mⁱ is a normal region.

For example, maximizing the posterior probability may be equivalent to minimizing a −log(·) value thereof. In this way, an objective function may be set, which includes a component (−log(P(Pₐ(εₓ)∥Mⁱ=1)) of the probability that the Mᵢ masked region is the abnormal region and a component (−log(P(P_{b}ⁱ(εₓ)|Mⁱ=0)) of the probability that the region not masked by Mⁱ is a normal region. In order to make the obtained region smoother, a component that makes Mⁱ boundary smooth may also be added.

In the above-described embodiments, it is proposed to observe the prediction error distributions of the respective pixels through a plurality of image inpainting operations, and determine whether there is any abnormality by analyzing the distribution. For example, whether there is abnormality in the corresponding region is determined by comparing the difference of two prediction error distributions.

Moreover, it is proposed to inpaint the abnormal region through image inpainting processing, so as to speculate a clean image without foreign matters; and through iterations, judgment of the abnormal region and speculation of the clean image are gradually improved.

FIG. 4 shows a block diagram of some embodiments of a processing apparatus of an abnormal region in an image according to the present disclosure.

As shown in FIG. 4, the processing apparatus 4 of the abnormal region in the image includes a generating circuit 41, a predicted value calculating circuit 42, a distribution calculating circuit 43, and a determining circuit 44.

The generating circuit 41 generates, for a region to be examined consisting of any one or more pixels in the image to be processed, a plurality of regions to be processed including the region to be examined.

The predicted value calculating circuit 42 respectively calculates the respective predicted pixel values of the region to be examined, by using the first machine learning model, according to pixel values in a preset range outside the respective regions to be processed.

The distribution calculating circuit 43 calculates the prediction error distributions corresponding to the respective predicted pixel values as a first error distribution, according to original pixel values of the region to be examined.

The determining circuit 44 determines whether the region to be examined belongs to the abnormal region in the image to be processed, according to the first error distribution.

In some embodiments, the determining circuit 44 determines whether the region to be examined belongs to the abnormal region in the image to be processed, according to whether the difference between the first error distribution and a second error distribution is greater than the first threshold. The second error distribution is capable of characterizing a prediction error distribution of an image not including the abnormal region.

In some embodiments, the distribution calculating circuit 43 determines the second error distribution in one of modes below: processing the prediction error distribution of other image not including the abnormal region according to the first machine learning model, and determining the second error distribution; determining the second error distribution, according to the standard deviation of the first error distribution of all pixels in the image to be processed; or, determining the second error distribution, by using the second machine learning model, according to the image to be processed.

In some embodiments, the processing apparatus 4 further includes a producing circuit 45, which is configured to execute a generation step, replace all pixels belonging to the abnormal region with corresponding predicted pixel values, and generate a candidate image; the distribution calculating circuit 43 executes an update step, and updates the second error distribution according to the candidate image, by using the plurality of regions to be processed and the first machine learning model, or updates the second error distribution according to the candidate image, by using the second machine learning model; the determining circuit 44 executes a determining step, and re-determines whether the region to be examined belongs to the abnormal region, according to whether the difference between the first error distribution and the updated second error distribution is greater than the first threshold.

In some embodiments, the producing circuit 45, the distribution calculating circuit 43, and the determining circuit 44 repeat the above-described steps until the iteration condition is met, so as to determine whether the respective pixels in the image to be processed belong to the abnormal region.

In some embodiments, the predicted value calculating circuit 42 calculates the respective predicted pixel values of the region to be examined in the candidate image, by using the first machine learning model, according to the plurality of regions to be processed; the distribution calculating circuit 43 determines the prediction error distribution of the region to be examined in the candidate image, according to the respective predicted pixel values of the candidate image; and the distribution calculating circuit 43 updates the second error distribution, by using the prediction error distribution of the region to he examined in the candidate image.

In some embodiments, the determining circuit 44 determines whether the respective regions to be examined in the image to be processed belong to the abnormal region, according to whether the difference between the second error distributions of the candidate image in two adjacent iterations is greater than a second threshold.

In some embodiments, the determining circuit 44 generates a candidate pixel set, according to the pixels determined to belong to the abnormal region, calculates a first probability that the respective pixels do not belong to the abnormal region, according to the second error distribution of the respective pixels in the candidate image, calculates a second probability of the respective pixels, according to the difference between the first error distribution and the second error distribution of the respective pixels in the candidate image, generates an objective function according to a posteriori probability of the pixel set determined based on the first probability and the second probability, and solves the objective function, by taking the pixels in the candidate pixel set as variables, and taking maximization of the posterior probability as a condition, so as to determine which pixels in the candidate image belong to the abnormal region.

In some embodiments, the producing circuit 45 is configured to determine a clean image not including the abnormal region, according to the candidate image generated when the iteration condition is met.

In some embodiments, the determining circuit 4 determines the difference according to cross entropy of the first error distribution and the second error distribution.

In some embodiments, the first threshold is determined according to the standard deviation of the difference.

In some embodiments, the generating circuit 41 forms a plurality of first blank regions by superimposing a plurality of masks on the image to be processed, which are respectively taken as one region to be processed of the respective first blank regions that includes a region to be examined, moves the plurality of masks to form a plurality of second blank regions, which are respectively taken as another region to be processed of the respective second blank region that includes a region to be examined, and constantly moves the plurality of masks, until all regions to be examined in the image to be processed have a plurality of regions to be processed.

In some embodiments, the image to be processed is a biological medical image, and the abnormal region is a non-biological region or an abnormal biological region; or the image to be processed is an industrial product image, and the abnormal region is a damaged region or a scratched region.

In some embodiments, the image segmentation apparatus according to the present disclosure includes: an examining circuit, which is configured to examine the abnormal region in the image to be processed, according to the processing method of the abnormal region in the image according to any one of the above-described embodiments; and a segmentation circuit, which is configured to perform image segmentation on the generated clean image not including the abnormal region, so as to determine an image segmentation result of the image to be processed.

FIG. 5 shows a block diagram of some embodiments of an electronic device according to the present disclosure.

As shown in FIG. 5, the electronic device 5 according to the embodiment includes: a memory 51 and a processor 52 coupled to the memory 51. The processor 52 is configured to execute the processing method of the abnormal region in the image or the image segmentation method according to any one of the above-described embodiments of the present disclosure, based on instructions stored in the memory 51.

The memory 51 may include, for example, a system memory, a fixed non-volatile storage medium, or the like. The system memory, for example, stores operating systems, applications, boot loaders, databases, and other programs.

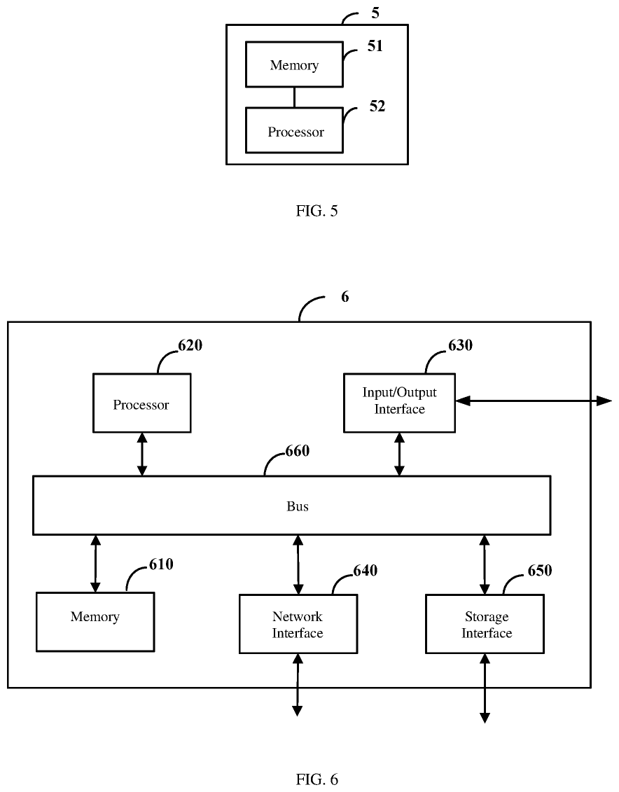

FIG. 6 shows a block diagram of other embodiments of an electronic device according to the present disclosure.

As shown in FIG. 6, the electronic device 6 according to this embodiment includes: a memory 610 and a processor 620 coupled to the memory 610. The processor 620 is configured to execute the processing method of the abnormal region in the image or the image segmentation method according to any one of the above-described embodiments, based on instructions stored in the memory 610.

The memory 610 may include, for example, a system memory, a fixed non-volatile storage medium, or the like. The system memory, for example, stores operating systems, applications, boot loaders, databases, and other programs.

The electronic device 6 may further include an input/output interface 630, a network interface 640, a storage interface 650, and the like. These interfaces 630, 640, 650 as well as the memory 610 and the processor 620 may be connected via a bus 660, for example. The input/output interface 630 provides connection interfaces for input/output devices such as a monitor, a mouse, a keyboard, a touch screen, a microphone, a speaker, etc. The network interface 640 provides connection interfaces for various networking devices. The storage interface 650 provides connection interfaces for SD card, USB flash disk and other external storage devices.

Those skilled in the art should understand that the embodiments of the present disclosure may be provided as a method, a system, or a computer program product. Therefore, the present disclosure may adopt a form of hardware only embodiments, software only embodiments, or embodiments with a combination of software and hardware. In addition, the present disclosure may adopt a form of a computer program product that is implemented on one or more computer-usable non-transitory storage media (including but not limited to a disk memory, a compact disc read-only memory (CD-ROM), an optical memory, etc.) that include computer-usable program codes.

Heretofore, according to the present disclosure, a detailed description has been provided. In order to avoid obscuring the concept of the present disclosure, some details known in the art are not described. Those skilled in the art can fully understand how to implement the technical solution disclosed herein according to the above description.

The method and the system according to the present disclosure may be implemented in many ways. For example, the method and the system according to the present disclosure may be implemented by software, hardware, firmware, or any combination of software, hardware, and firmware. The above-described order of steps used for the method is only for illustration, and the steps of the method according to the present disclosure are not limited to the order as described above, unless otherwise specifically illustrated. In addition, in some embodiments, the present disclosure may also be implemented as programs recorded in a recording medium, and these programs include machine readable instructions for implementing the method according to the present disclosure. Thus, the present disclosure further covers a recording medium configured to store the program for executing the method according to the present disclosure.

Although some specific embodiments of the present disclosure have been illustrated in detail by examples, those skilled in the art should understand that the above-described examples are only for illustration, not to limit the scope of the present disclosure. Those skilled in the art should understand that the above embodiments may be modified without departing from the scope and spirit of the present disclosure. The scope of the present disclosure is defined by the appended claims.

1. A processing method of an abnormal region in an image, comprising:
generating, for a region to be examined consisting of any one or more pixels in an image to be processed, a plurality of regions to be processed comprising the region to be examined;
respectively calculating respective predicted pixel values of the region to be examined, by using a first machine learning model, according to pixel values in a preset range outside respective regions to be processed;
calculating prediction error distributions corresponding to the respective predicted pixel values as a first error distribution, according to original pixel values of the region to be examined; and
determining whether the region to be examined belongs to the abnormal region in the image to be processed, according to the first error distribution.

2. The processing method according to claim 1, wherein determining whether the region to be examined belongs to the abnormal region in the image to be processed, according to the first error distribution, comprises:
determining whether the region to be examined belongs to the abnormal region in the image to be processed, according to whether a difference between the first error distribution and a second error distribution is greater than a first threshold, wherein the second error distribution is capable of characterizing a prediction error distribution of an image not comprising the abnormal region.

3. The processing method according to claim 2,
wherein the second error distribution is determined in one of modes below:
determining the second error distribution according to the first machine learning model processing prediction error distributions of other images not comprising the abnormal region;
determining the second error distribution according to a standard deviation of first error distributions of all pixels in the image to be processed; or
determining the second error distribution by using a second machine learning model, according to the image to be processed.

4. The processing method according to claim 2, wherein determining whether the region to be examined belongs to the abnormal region in the image to be processed, according to whether the difference between the first error distribution and the second error distribution is greater than the first threshold, comprises:
a generation step: replacing all pixels belonging to the abnormal region with corresponding predicted pixel values to generate a candidate image;
an update step: updating the second error distribution according to the candidate image, by using the plurality of regions to be processed and the first machine learning model, or updating the second error distribution according to the candidate image, by using a second machine learning model; and
a determining step: re-determining whether the region to be examined belongs to the abnormal region, according to whether the difference between the first error distribution and the second error distribution that is updated is greater than the first threshold.

5. The processing method according to claim 4, wherein determining whether the region to be examined belongs to the abnormal region in the image to be processed, according to whether the difference between the first error distribution and the second error distribution is greater than the first threshold, comprises:
repeating the generation step, the update step, and the determining step, until an iteration condition is met, so as to determine whether respective regions to be examined in the image to be processed belong to the abnormal region.

6. The processing method according to claim 4, wherein updating the second error distribution according to the candidate image, by using the plurality of regions to be processed and the first machine learning model, comprises:
calculating respective predicted pixel values of the region to be examined in the candidate image, by using the first machine learning model, according to the plurality of regions to be processed;
determining a prediction error distribution of the region to be examined in the candidate image, according to the respective predicted pixel values of the candidate image; and
updating the second error distribution, by using the prediction error distribution of the region to be examined in the candidate image.

7. The processing method according to claim 4, wherein re-determining whether the region to be examined belongs to the abnormal region, according to whether the difference between the first error distribution and the second error distribution that is updated is greater than the first threshold, comprises:
determining whether respective regions to be examined in the image to be processed belong to the abnormal region, according to whether a difference between second error distributions of candidate images in two adjacent iterations is greater than a second threshold.

8. The processing method according to claim 4, wherein re-determining whether the region to be examined belongs to the abnormal region, according to whether the difference between the first error distribution and the second error distribution that is updated is greater than the first threshold, comprises:
generating a candidate pixel set, according to the pixels determined to belong to the abnormal region;
calculating a first probability that respective pixels do not belong to the abnormal region, according to the second error distribution of the respective pixels in the candidate image, and calculating a second probability of the respective pixels, according to the difference between the first error distribution and the second error distribution of the respective pixels in the candidate image;
generating an objective function, according to a posteriori probability of the candidate pixel set determined based on the first probability and the second probability; and
solving the objective function by taking the pixels in the candidate pixel set as variables and taking maximization of the posterior probability as a condition, so as to determine which pixels in the candidate image belong to the abnormal region.

9. The processing method according to claim 4, further comprising:
determining a clean image not comprising the abnormal region, according to the candidate image generated when an iteration condition is met.

10. The processing method according to claim 2, wherein determining whether the region to be examined belongs to the abnormal region in the image to be processed, according to whether the difference between the first error distribution and the second error distribution is greater than the first threshold, comprises:
determining the difference according to cross entropy of the first error distribution and the second error distribution.

11. The processing method according to claim 2,
wherein the first threshold is determined according to a standard deviation of the difference.

12. The processing method according to claim 1, wherein generating, for the region to be examined consisting of any one or more pixels in the image to be processed, the plurality of regions to be processed comprising the region to be examined, comprises:
by superimposing a plurality of masks on the image to be processed, forming a plurality of first blank regions which are respectively taken as one region to be processed of the respective first blank regions that comprises a region to be examined;
moving the plurality of masks to form a plurality of second blank regions, which are respectively taken as another region to be processed of the respective second blank regions that comprises a region to be examined; and
constantly moving the plurality of masks, until all regions to be examined in the image to be processed have a plurality of regions to be processed.

13. The processing method according to claim 1,
wherein the image to be processed is a biological medical image, and the abnormal region is a non-biological region or an abnormal biological region; or
the image to be processed is an industrial product image, and the abnormal region is a damaged region or a scratched region.

14. An image segmentation method, comprising:
examining an abnormal region in an image to be processed, according to the processing method of the abnormal region in the image according to claim 1; and
performing image segmentation on a generated clean image not comprising the abnormal region, so as to determine an image segmentation result of the image to be processed.

15. A processing apparatus of an abnormal region in an image, comprising:
a generating circuit, configured to generate, for a region to be examined consisting of any one or more pixels in an image to be processed, a plurality of regions to be processed comprising the region to be examined;
a predicted value calculating circuit, configured to respectively calculate respective predicted pixel values of the region to be examined, by using a first machine learning model, according to pixel values in a preset range outside respective regions to be processed;
a distribution calculating circuit, configured to calculate prediction error distributions corresponding to the respective predicted pixel values as a first error distribution, according to original pixel values of the region to be examined; and
a determining circuit, configured to determine whether the region to be examined belongs to the abnormal region in the image to be processed, according to the first error distribution.

16. An image segmentation apparatus, comprising:
an examining circuit, configured to examine an abnormal region in an image to be processed, according to the processing method of the abnormal region in the image according to claim 1; and
a segmentation circuit, configured to perform image segmentation on a generated clean image not comprising the abnormal region, so as to determine an image segmentation result of the image to be processed.

17. An electronic device, comprising:
a memory; and
a processor coupled to the memory, wherein the processor is configured to execute the processing method of the abnormal region in the image according to claim 1, based on instructions stored in the memory.

18. A non-volatile computer readable storage medium, having a computer program stored thereon, wherein the program, when executed by a processor, implements the processing method of the abnormal region in the image according to claim 1.

19. An electronic device, comprising:
a memory; and
a processor coupled to the memory, wherein the processor is configured to execute the image segmentation method according to claim 14, based on instructions stored in the memory.

20. A non-volatile computer readable storage medium, having a computer program stored thereon, wherein the program, when executed by a processor, implements the image segmentation method according to claim 14.
